(19) United States
(12) Patent Application Publication
(10) Pub. No.: US 2021/0118280 A1
(43) Pub. Date: Apr. 22, 2021

(54) Object Locating and Reminder System

(71) Applicant: Aaron A. Tobler, SR., Orange Park, FL (US)

(72) Inventor: Aaron A. Tobler, SR., Orange Park, FL (US)

(21) Appl. No.: 17/076,007

(22) Filed: Oct. 21, 2020

Related U.S. Application Data
(60) Provisional application No. 62/924,310, filed on Oct. 22, 2019.

(51) Int. Cl. G08B 21/24; H04B 1/3827; G08B 3/10

(52) U.S. Cl. CPC G08B 21/24; G08B 3/10; H04B 1/3827

(57) ABSTRACT

An object locating and reminder system is shown and described. The object locating and reminder system includes a first device that includes a power source. The power source is operably coupled to a proximity sensor. The proximity sensor is in wireless communication with at least a second device. The second device includes a power source. The power source is operably coupled to a wireless transceiver. The power source and the wireless transceiver are coupled to a speaker.

### CROSS REFERENCE TO RELATED APPLICATIONS

This application claims the benefit of U.S. Provisional Application No. 62/924,310 filed on Oct. 22, 2019. The above identified patent application is herein incorporated by reference in its entirety to provide continuity of disclosure.

### BACKGROUND OF THE INVENTION

The present invention relates to an object reminder system. More particularly, the present invention provides a system that will trigger an alarm when an object is missing or exits a defined distance of a host device.

Many people tend to place important items down near them. Later, when the individual leaves the area, the items are then forgotten. In many cases, these items include wallets, keys, and cellular devices. These items are difficult to find if left in a public area. It would be helpful if the items were not forgotten and then lost.

In some instances, individuals place items around their home. They later forget where the items are placed. At times, these items fall into an area where they are difficult to find. Into the crevasse of a couch, for example. It may be extremely difficult to then find these items as they do not make noise or other forms of attractants.

In yet other instances, some individuals need to keep track of another individual. In one example, a child's location will need to be determined. In other examples, elderly people will need to be located. In either instance, these individuals may wander away from caregivers and need to be quickly located.

Consequently there is a need for an improvement in the art of object detection. The present invention substantially diverges in design elements from the known art while at the same time solves a problem many people lace when having to remember where items are or locating missing items. In this regard the present invention substantially fulfills these needs.

### SUMMARY OF THE INVENTION

The present invention provides an object locating and reminder system wherein the same can be utilized for providing convenience for the user when attempting to locate a lost item or individual. The object locating and reminder system is comprised of a first device, the first device comprising a power source. The power source is operably coupled to a proximity sensor. The proximity sensor is in wireless communication with at least a second device. The second device comprising a power source. The power source is operably coupled to a wireless transceiver. The power source and the wireless transceiver are coupled to a speaker.

Another object of the object locating and reminder system is to have a first device which further includes a housing.

Another object of the object locating and reminder system is to have the housing of the first device include an attachment clip.

Another object of the object locating and reminder system is to have the first device further include a speaker coupled to the proximity sensor.

Another object of the object locating and reminder system is to have the first device further include a distance selector to determine a distance threshold of the proximity sensor.

Another object of the object locating and reminder system is to have the second device include a housing.

Another object of the object locating and reminder systemis to have the second housing include an attachment clip.

Another object of the object locating and reminder system is to have the first device further include an adhesive located on one side thereof.

Another object of the object locating and reminder system is to have the second device include an adhesive located on one side thereof.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of a location device of the object locating and reminder system.

FIG. 1B shows a wiring diagram of an embodiment of the location device of the object locating and reminder system

FIG. 2A shows a perspective view of an alternative embodiment of a location device of the object locating and reminder system.

FIG. 2B shows a wiring diagram of an alternative embodiment of the location device of the object locating and reminder system.

FIG. 3 shows a perspective view of an embodiment of a device that connects to a smart phone of the object locating and reminder system.

FIG. 4 shows an in-use view of an embodiment of the object locating and reminder system.

### LIST OF REFERENCE NUMERALS

With regard to the reference numerals used, the following numbering is used throughout the drawings.
101 Housing
102 Top section
103 Attachment clip
104 Power source
105 Proximity Sensor
106 Speaker
107 Wireless transceiver
201 Sticker device
202 Adhesive
203 Removable backing
204 Power source
205 RFID chip
206 Power source
301 Secondary device
302 Location device
303 Connection terminal
304 Proximity selector
305 Movable switch
306 Channel
307 Distances
401 First location device
402 Second location device

### DETAILED DESCRIPTION OF THE INVENTION

Reference is made herein to the attached drawings. Like reference numerals are used throughout the drawings to depict like or similar elements of the object locating and reminder system. For the purposes of presenting a brief and clear description of the present invention, a preferred embodiment will be discussed as used for the object locating and reminder system. The figures are intended for representative purposes only and should not be considered to be limiting in any respect.

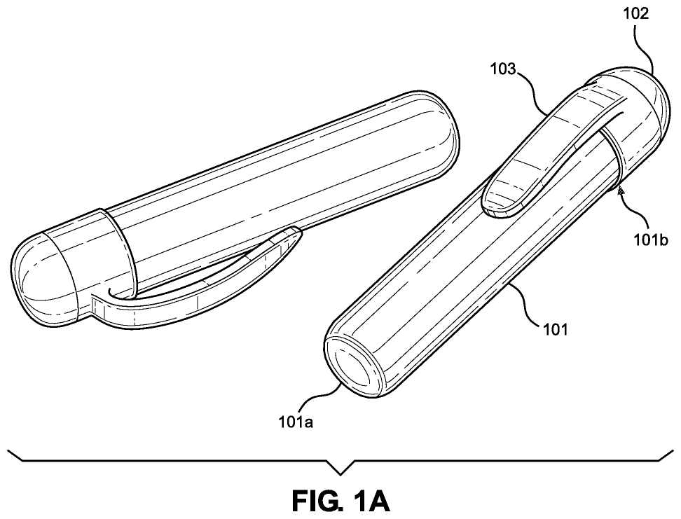

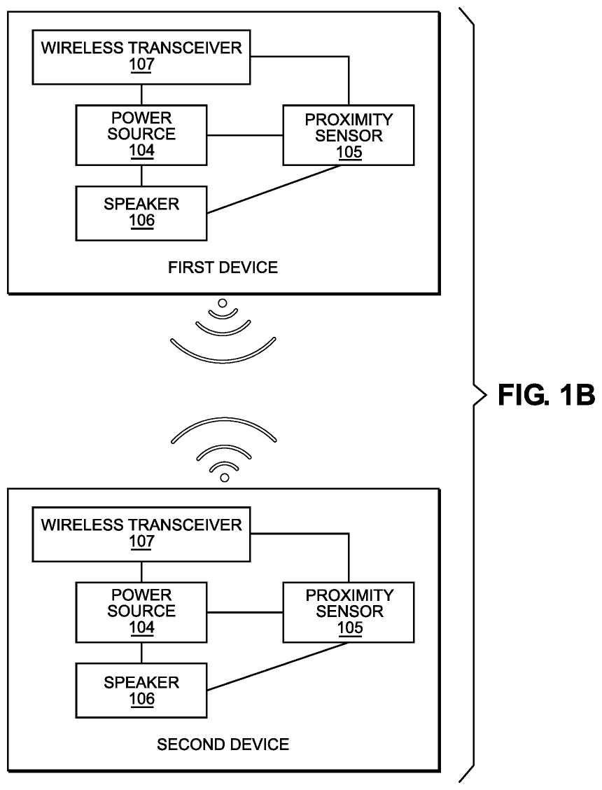

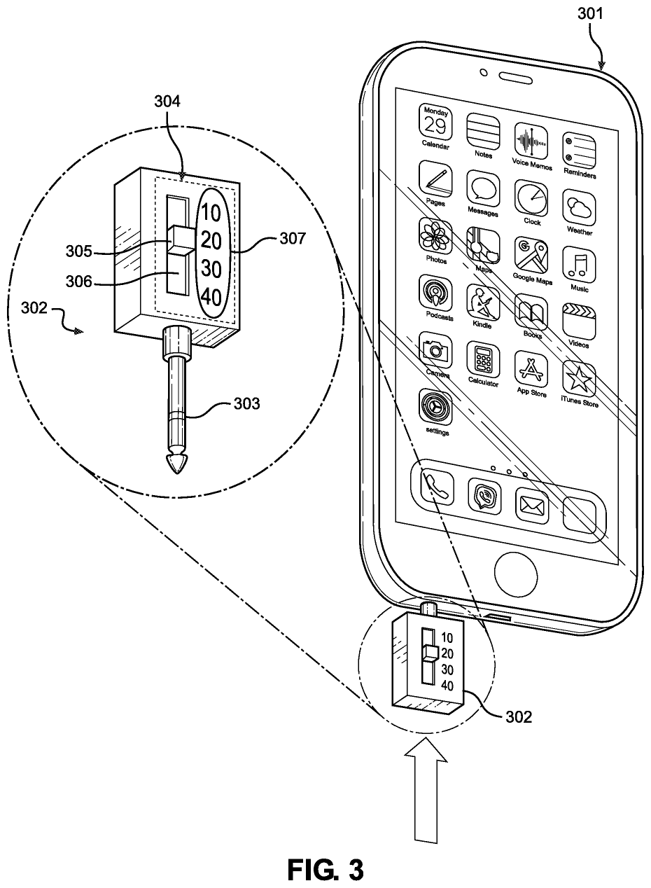

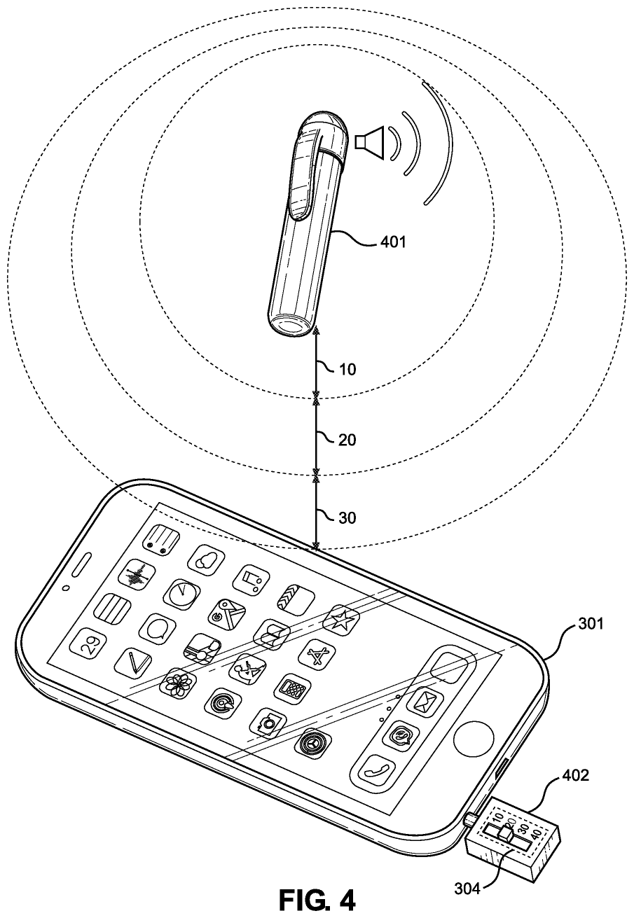

Referring now to FIG. 1A and FIG. 1B, there is shown a perspective view and a wiring diagram of an embodiment of a location device of the object locating and reminder system. In one embodiment, the object and location reminder system is a standalone system. This means that the system will have its own independent parts and not require ny additional devices to function as described in FIG. 3 and FIG. 4. In one embodiment, the location devices of the system include a housing 101. In one embodiment, the housing 101 has closed end first 101a and a second end 101b. In one embodiment, the housing 101 has a cylindrical cross-section. This will allow the device to fit comfortably in a pocket.

In one embodiment, the second end 101b of the housing has a top section 102 removably secured thereto. The top section 102 will allow for access to the interior volume of the housing 101 when removed. In one embodiment, this will hold a power source 104 for the device as described below. In a further embodiment, the top section 102 has a securement clip 103 attached thereto. In one embodiment, the securement clip 103 is attached to the top section 102 and extends along the body of the housing 101. The securement clip 103 will apply pressure to the housing 101 to secure an article therein, securing the device.

While the current device is shown and described above, this is not meant to be limiting to the size shape or type of device used. It is part of this disclosure that other devices may be used having the parts as described below to achieve the necessary functions of this disclosure. In one embodiment, the device could be a bracelet. In another embodiment, the device could be a necklace. In yet another embodiment, the necessary parts and functions could be incorporated into a different device that a user would already have on their person.

Each locating device will include a power source 104. In one embodiment, the power source 104 is a battery. In other embodiments, other power sources may be used. The power source 104 is electrically coupled to a proximity sensor 105. The proximity sensor 105 will determine the distance from other devices. In one embodiment, the proximity sensor 105 will have an adjustable detection distance thereon as described below. The proximity sensor 105 is electrically coupled to a speaker 106 and a wireless transceiver 107. The wireless transceiver 107 will send signals to other devices. In one embodiment, these signals will allow the proximity sensor 105 determine distances based on the time it takes the signals to reach the other device. The speaker 106 is configured to output a sound. The speaker will be triggered to output a sound as explained in the description of FIG. 4.

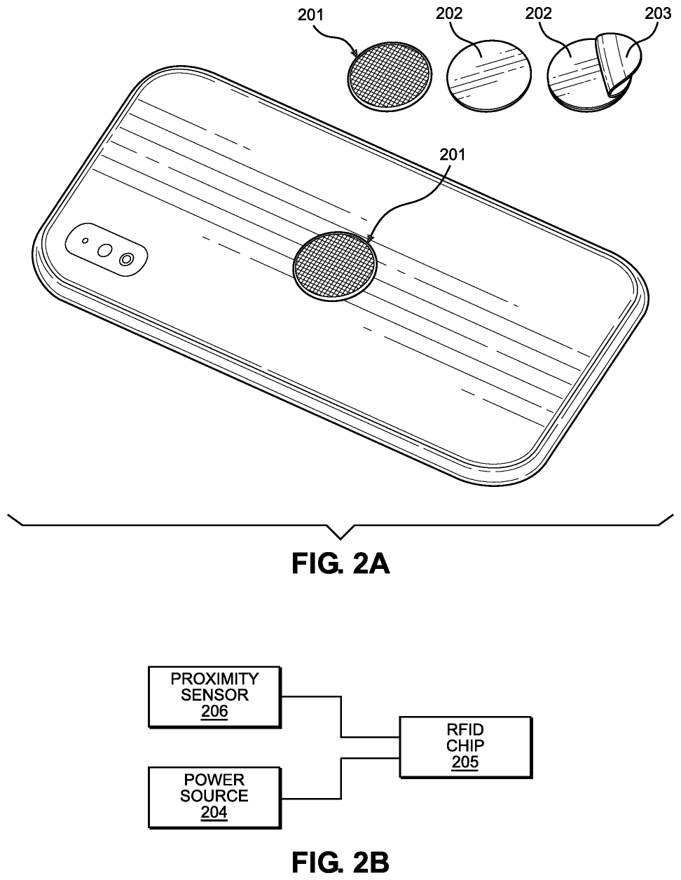

Referring now to FIG. 2A and FIG. 2B, there is shown a perspective view and a wiring diagram of an alternative embodiment of a location device of the object locating and reminder system. In another embodiment, there is at least one device which will be in communication with a proximity device. In some embodiments the proximity device will have fewer items included. For, example the proximity device will not have a speaker or a wireless transceiver. In one embodiment, the proximity device is a sticker device 201. The sticker device 201 is comprised of a housing having an interior volume. In some embodiment the sticker device 201 is only a few millimeters thick. The sticker device 201 has an adhesive 202 located on one side thereof. The adhesive 202 will allow the sticker device 201 to be secured to various devices. In some embodiments the sticker device 201 has a removable backing 203. The removable backing 203 will prevent the sticker device 201 from sticking to items unwantedly.

In one embodiment, the sticker device includes a power source 204. The power source 204 is electrically coupled to a RFID chip 205. The RFID chip 205 will allow another device to connect to the sticker device 201. The RFID chip 205 is electrically connected to a proximity sensor 206. This will allow the device to help determine the proximity to another device. In some embodiments, the device may include a small light thereon. In yet another embodiment, there is a speaker located on the sticker device 201.

Referring now to FIG. 3, there is shown a perspective view of an embodiment of a device that connects to a smart phone of the object locating and reminder system. In one embodiment, a locating device is configured to secure to a secondary device 301. In the shown embodiment, the secondary device 301 is a smart phone. In another embodiment, the secondary device 301 is a laptop. In yet a further embodiment, a secondary device 301 is a portable game system.

In the shown embodiment, the location device 302 is comprised of a housing. The housing will enclose a proximity sensor. The proximity sensor will be electrically coupled to a connection terminal 303. In the shown embodiment, the connection terminal 303 is shown as a headphone jack. In other embodiments, the connection terminal 303 is a USB connection. In yet a further embodiment, the connection terminal 303 is specially adapted to secure to various devices with unique connections.

In some embodiments, the location device 302 will include a proximity selector 304. In one embodiment, the proximity selector 304 is a movable switch 305. The movable switch 305 is located within a channel 306. In the shown embodiment there are distances 307 located next to the channel 306. These distances 307 will determine when a proximity alarm is triggered as described in the description of FIG. 4.

Once the location device 302 is connected to secondary device 301, the location device 302 will gain access to the secondary device's power source. In further embodiments the location device 302 will further gain access to the secondary device's 301 wireless transceiver. In one embodiment, the location device 302 will access a secondary device's 301 speaker. This will allow the location to device to trigger a proximity alarm as described in the description of FIG. 4.

Referring now to FIG. 4, there is shown an in-use view of an embodiment of the object locating and reminder system. In the shown embodiment, a first location device 401 is wirelessly connected to a second location device 402. The second location device 402 is secured to a secondary device 301. The second location device 402 then accesses the necessary items of the secondary device 301 as described above.

The second location device 402 has a proximity selector 304 located thereon. In the shown embodiment, the proximity selector 304 is set to 20 units of distance. Any unit of distance may be used. In the shown embodiment, the first location device 401 and the second location device 402 are over 20 units of distance apart.

Once the proximity of the first location device 401 and the second location device 402 are not within the 20-unit proximity, the proximity sensors of both devices 401, 402 will trigger an alarm. In the shown embodiment, both devices 401, 402 will trigger an audible alarm via the speakers. In other embodiments, depending on the location devices used only one device will trigger an audible alarm. In some embodiments, the alarm will further include a lighted alarm. This will alarm an individual that they have left in item behind that is no longer in the set proximity.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An object locating and reminder system, the system comprising:
a first device, the first device comprising a first power source;
the first power source is operably coupled to a first proximity sensor;
the first proximity sensor is in wireless communication with at least a second device;
the second device comprising a second power source;
the second power source is operably coupled to a second wireless transceiver;
the second power source and the second wireless transceiver are coupled to a second speaker.

2) The object locating and reminder system of claim 1, wherein the first device further comprises a first housing.

3) The object locating and reminder system of claim 2, wherein the first housing includes a first attachment clip.

4) The object locating and reminder system of claim 1, wherein the first device further comprises a first speaker coupled to the first proximity sensor.

5) The object locating and reminder system of claim 1, wherein the first device further comprises a first distance selector to determine a distance threshold of the first proximity sensor.

6) The object locating and reminder system of claim 1, wherein the second device further comprises a second housing.

7) The object locating and reminder system of claim 6, wherein the second housing includes a second attachment clip.

8) The object locating and reminder system of claim 1, wherein the first device further comprises an adhesive located on one side thereof.

9) The object locating and reminder system of claim 1, wherein the second device has an adhesive located on one side thereof.

10) An object locating and reminder system, the system comprising:
a first device, the first device having an electrical connection configured to connect to a mobile device;
the first device contains a first proximity sensor in wireless communication with a second device;
the second device comprises a second wireless transceiver and a second proximity sensor.

11) The object locating and reminder system of claim 10, wherein the first device further comprises a first housing.

12) The object locating and reminder system of claim 10, wherein the first device further comprised a first speaker coupled to the first proximity sensor.

13) The object locating and reminder system of claim 10, wherein the first device further comprises a distance selector to determine a distance threshold of the first proximity sensor.

14) The object locating and reminder system of claim 13, wherein the distance selector is a switch located on the first device.

15) The object locating and reminder system of claim 10, wherein the second device further comprises a second housing.

16) The object locating and reminder system of claim 15, wherein the housing includes a second attachment clip.

17) The object locating and reminder system of claim 10, wherein the second device has an adhesive located on one side thereof.
